(19) United States
(12) Patent Application Publication
(10) Pub. No.: US 2024/0302589 A1
(43) Pub. Date: Sep. 12, 2024

(54) OPTOELECTRONIC PACKAGE STRUCTURE

(71) Applicant: Advanced Semiconductor Engineering, Inc., Kaohsiung (TW)

(72) Inventors: Jr-Wei LIN, Kaohsiung (TW); Mei-Ju LU, Kaohsiung (TW); Wen Chieh YANG, Kaohsiung (TW)

(73) Assignee: Advanced Semiconductor Engineering, Inc., Kaohsiung (TW)

(21) Appl. No.: 18/120,346

(22) Filed: Mar. 10, 2023

(51) Int. Cl. G02B 6/122

(52) U.S. Cl. CPC G02B 6/122

(57) ABSTRACT

An optoelectronic package structure is provided. The optoelectronic package structure includes a first photonic component, a second photonic component, and an interposer. The first photonic component is disposed over the second photonic component. The interposer is optically coupled between the first photonic component and the second photonic component. The interposer is configured to define a first signal path therebetween.

### BACKGROUND

### 1. Field of the Disclosure

The present disclosure relates to an optoelectronic package structure and in particular to an optoelectronic package structure including an interposer configured to transmit a signal between multiple photonic components.

### 2. Description of the Related Art

A photonic component (e.g., a silicon-photonic) may be configured to transmit optical signals and be applicable to optical communication fields. Current photonic components receive optical signals via connection to optical fibers. However, it is a challenge to package multiple photonic components at different elevations and to communicate among said photonic components. Therefore, an improved optoelectronic package structure is called for.

### SUMMARY

In some embodiments, an optoelectronic package structure includes a first photonic component, a second photonic component, and an interposer. The first photonic component is disposed over the second photonic component. The interposer is optically coupled between the first photonic component and the second photonic component. The interposer is configured to define a first signal path therebetween.

In some embodiments, an optoelectronic package structure includes an interposer. The interposer is configured to transmit a first optical signal along a vertical direction and configured to transmit a second optical signal along a horizontal direction.

In some embodiments, an optoelectronic package structure includes a first photonic component, a second photonic component, and an interposer. The interposer is configured to communicate the first photonic component and the second photonic component. The interposer includes a first waveguide optically coupled with the first photonic component and a second waveguide spaced apart from the first waveguide and optically coupled with the second photonic component.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1 is a top view of an exemplary optoelectronic package structure according to some embodiments of the present disclosure.

FIG. 2 is a cross-section of an optoelectronic package structure according to some embodiments of the present disclosure.

FIG. 3 is a cross-section of an interposer of an optoelectronic package structure according to some embodiments of the present disclosure.

FIG. 4 illustrates a layout of an interposer of an optoelectronic package structure according to some embodiments of the present disclosure.

FIG. 5 is a cross-section of an optoelectronic package structure according to some embodiments of the present disclosure.

FIG. 6 is a cross-section of an optoelectronic package structure according to some embodiments of the present disclosure.

FIG. 7 is a cross-section of an optoelectronic package structure according to some embodiments of the present disclosure.

FIG. 8A illustrates a layout of optical contacts of an optoelectronic package structure according to some embodiments of the present disclosure.

FIG. 8B illustrates a layout of optical contacts of an optoelectronic package structure according to some embodiments of the present disclosure.

FIG. 9A illustrates one or more stages of an exemplary method for manufacturing an optoelectronic package structure according to some embodiments of the present disclosure.

FIG. 9B illustrates one or more stages of an exemplary method for manufacturing an optoelectronic package structure according to some embodiments of the present disclosure.

FIG. 9C illustrates one or more stages of an exemplary method for manufacturing an optoelectronic package structure according to some embodiments of the present disclosure.

FIG. 9D illustrates one or more stages of an exemplary method for manufacturing an optoelectronic package structure according to some embodiments of the present disclosure.

Common reference numerals are used throughout the drawings and the detailed description to indicate the same or similar components. Embodiments of the present disclosure will be readily understood from the following detailed description taken in conjunction with the accompanying drawings.

### DETAILED DESCRIPTION

The following disclosure provides many different arrangements, or examples, for implementing different features of the provided subject matter. Specific examples of components and arrangements are described as follows. These are, of course, merely examples and are not intended to be limiting. In the present disclosure, reference to the formation or disposal of a first feature over or on a second feature in the description that follows may include arrangements in which the first and second features are formed or disposed in direct contact, and may also include arrangements in which one or more additional features may be formed or disposed between the first and second features, such that the first and second features may not be in direct contact. In addition, the present disclosure may repeat reference numerals and/or letters in the various examples. The same reference numerals and/or letters refer to the same or similar parts. This repetition is for the purpose of simplicity and clarity and does not in itself dictate a relationship between the various arrangements and/or configurations.

Arrangements of the present disclosure are discussed in detail as follows. It should be appreciated, however, that the present disclosure provides many applicable concepts that can be embodied in a wide variety of specific contexts. The specific arrangements discussed are merely illustrative and do not limit the scope of the disclosure.

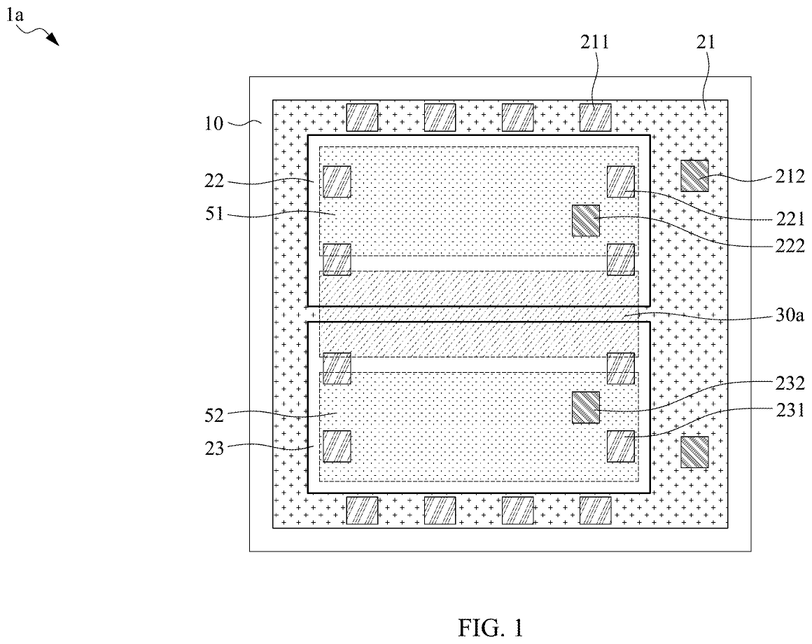

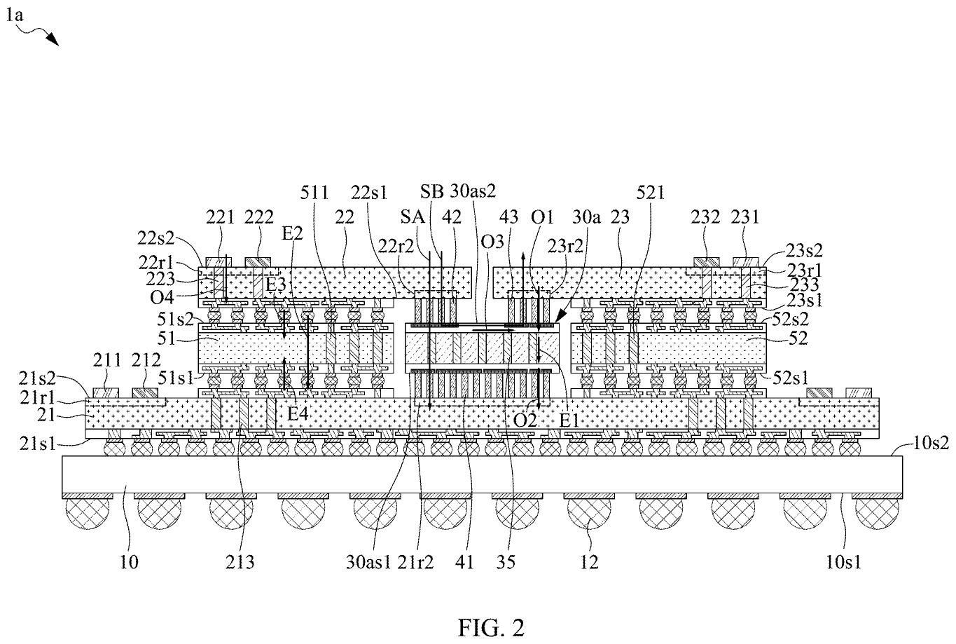

FIG. 1 is a top view of an exemplary optoelectronic package structure 1a according to some embodiments of the present disclosure. FIG. 2 is a cross-section of the optoelectronic package structure 1a according to some embodiments of the present disclosure. In some embodiments, the optoelectronic package structure 1a may include a carrier 10, photonic components 21, 22, and 23, an interposer 30a, optical contacts 41, 42, and 43, as well as electronic components 51 and 52. It should be noted that the number of the photonic components, electronic components, and/or other components may vary according to actual applications and is not limited thereto.

As shown in FIG. 1, the photonic component 21 may cover the carrier 10. In some embodiments, the photonic component 22 may cover the electronic component 51. In some embodiments, the photonic component 22 may cover a portion of the interposer 30a. In some embodiments, the photonic component 22 may cover a portion of the photonic component 21. In some embodiments, a gap (not annotated) between the electronic component 51 and the interposer 30a may be covered by the photonic component 22.

In some embodiments, the photonic component 23 may cover the electronic component 52. In some embodiments, the photonic component 23 may cover a portion of the interposer 30a. In some embodiments, the photonic component 23 may cover a portion of the photonic component 21. In some embodiments, a gap (not annotated) between the electronic component 52 and the interposer 30a may be covered by the photonic component 23.

In some embodiments, the photonic component 21 may include an optical receiving element 211 and an optical emitting element 212. The optical receiving element 211 and the optical emitting element 212 may be disposed on or disposed over a peripheral region (not annotated) of an upper surface, which is not covered by the photonic components 22 and 23, of the photonic component 21.

In some embodiments, the photonic component 22 may include an optical receiving element 221 and an optical emitting element 222. In some embodiments, the optical receiving element 221 and the optical emitting element 222 may be disposed on or disposed over an upper surface of the photonic component 22.

In some embodiments, the photonic component 23 may include an optical receiving element 231 and an optical emitting element 232. In some embodiments, the optical receiving element 231 and the optical emitting element 232 may be disposed on or disposed over an upper surface of the photonic component 23.

As shown in FIG. 2, the carrier 10 may be configured to support the photonic components 21. The carrier 10 may include a surface 10s1 (or a lower surface) and a surface 10s2 (or an upper surface) opposite to the surface 10s1. The carrier 10 may include, for example, a printed circuit board, such as a paper-based copper foil laminate, a composite copper foil laminate, or a polymer-impregnated glass-fiber-based copper foil laminate. The carrier 10 may include an interconnection structure, which may include such as a plurality of conductive traces and/or a plurality of conductive vias. The interconnection structure may include a redistribution layer (RDL) and/or a grounding element. In some embodiments, the carrier 10 may include a two-layer substrate which includes a core layer and a conductive material and/or structure disposed on the surface 10s1 and/or 10s2 of the carrier 10. The conductive material and/or structure may include a plurality of traces. The carrier 10 may include one or more conductive pads in proximity to, adjacent to, or embedded in and exposed by the surface 10s1 and/or 10s2 of the carrier 10. The carrier 10 may include a solder resist (not shown) on the surface 10s1 and/or 10s2 of the carrier 10 to fully expose or to expose at least a portion of the conductive pads for electrical connections.

In some embodiments, the optoelectronic package structure 1a may include electrical connections 12. The electrical connection 12 may be disposed on or disposed over the surface 10s1 of the carrier 10. The electrical connection 12 may be configured to electrically connect the optoelectronic package structure 1a and an external device (not shown). The electrical connection 12 may be or include conductive bumps, solder balls, or the like. The electrical connection 12 may include one or more materials, such as alloys of gold and tin solder or alloys of silver and tin solder.

The photonic component 21 may be disposed on or disposed over the surface 10s2 of the carrier 10. The photonic component 21 may be configured to process, receive, and/or transmit optical and/or electrical signals. In some embodiments, the photonic component 21 may be configured to convert an optical signal to an electrical signal. In some embodiments, the photonic component 21 may be configured to convert an electrical signal to an optical signal. The photonic component 21 may include, but is not limited to, a photonic integrated circuit (PIC) and/or other suitable ICs. The photonic component 21 may have a surface 21s1 (or a lower surface) and a surface 21s2 (or an upper surface) opposite to the surface 21s1. The photonic component 21 may include a redistribution structure (not annotated) over the surface 21s1 and/or 21s2, which may be configured to transmit an electrical signal to the carrier 10 and/or electronic component 51.

In some embodiments, the optical receiving element 211 may be disposed on or disposed over the surface 21s2 of the photonic component 21. The optical receiving element 211 may be configured to receive an optical signal. The optical receiving element 211 may be coupled with an optical contact region 21r1 of the photonic component 21. In some embodiments, the optical receiving element 211 may include a fiber array unit (FAU) or other suitable elements.

In some embodiments, the optical emitting element 212 may be disposed on or disposed over the surface 21s2 of the photonic component 21. The optical emitting element 212 may be configured to transmit an optical signal (or a processed optical signal). The optical emitting element 212 may be coupled with the optical contact region 21r1 of the photonic component 21. In some embodiments, the optical emitting element 212 may include a laser diode or other suitable elements.

In some embodiments, the photonic component 21 may include a plurality of optical channels 213. The optical channel 213 may be configured to receive and/or transmit an optical signal. The optical channel 213 may be optically coupled with the optical receiving element 211. The optical channel 213 may be optically coupled with the optical emitting element 212. The optical channel 213 may extend between the surfaces 21s1 and 21s2 of the photonic component 21. The optical channel 213 may include or be made of silicon, silicon nitride (Si₃N₄), lithium niobate (LiNbO₃), or a combination thereof. In some embodiments, the photonic component 21 may include an electrical-to-optical converter (not shown) and an optical-to-electrical converter (not shown) to convert an optical signal and/or an electrical signal.

In some embodiments, the electronic component 51 may be disposed on or disposed over the surface 21s2 of the photonic component 21. The electronic component 51 may be configured to process and/or modulate an electrical signal. For example, the electronic component 51 may be configured to amplify an electrical signal. In some embodiments, the electronic component 51 can include, but is not limited to, an electronic integrated circuit (EIC) and/or other suitable ICs. In some embodiments, the electronic component 51 may include an application-specific integrated circuit (ASIC), an amplifier IC or other suitable ICs. The electronic component 51 may have a surface 51s1 (or a lower surface) and a surface 51s2 (or an upper surface) opposite to the surface 51s1. The surface 51s1 of the electronic component 51 may face the surface 21s2 of the photonic component 21.

In some embodiments, the electronic component 51 may include a plurality of conductive vias 511. The conductive via 511 may extend between the surfaces 51s1 and 51s2 of the electronic component 51. In some embodiments, the conductive via 511 may be configured to receive and/or transmit an electrical signal (or a processed electrical signal). The conductive via 511 may include, for example, a through-silicon via (TSV) or other suitable elements. The electronic component 51 may include redistribution structures (not annotated) over the surfaces 51s1 and 51s2. The electronic component 51 may include electrical connections (not annotated), such as solder balls, over the surfaces 51s1 and 51s2.

The photonic component 22 may be disposed on or disposed over the surface 51s2 of the electronic component 51. The photonic component 22 may be configured to process, receive, and/or transmit optical and/or electrical signals. In some embodiments, the photonic component 22 may be configured to convert an optical signal to an electrical signal. In some embodiments, the photonic component 22 may be configured to convert an electrical signal to an optical signal. The photonic component 22 may include, but is not limited to, a PIC and/or other suitable ICs. The photonic component 22 may have a surface 22s1 (or a lower surface) and a surface 22s2 (or an upper surface) opposite to the surface 22s1. The surface 22s1 may face the surface 51s2 of the electronic component 51. The photonic component 22 may include a redistribution structure (not annotated) over the surface 22s1, which may be configured to transmit an electrical signal (or a processed signal) to the electronic component 51.

In some embodiments, the optical receiving element 221 may be disposed on or disposed over the surface 22s2 of the photonic component 22. The optical receiving element 221 may be configured to receive an optical signal. The optical receiving element 221 may be coupled with an optical contact region 22r1 of the photonic component 22. In some embodiments, the optical receiving element 221 may include a FAU or other suitable elements.

In some embodiments, the optical emitting element 222 may be disposed on or disposed over the surface 22s2 of the photonic component 22. The optical emitting element 222 may be configured to transmit an optical signal (or a processed optical signal). The optical emitting element 222 may be coupled with the optical contact region 22r1 of the photonic component 22. In some embodiments, the optical emitting element 222 may include a laser diode or other suitable elements.

In some embodiments, the photonic component 22 may include a plurality of optical channels 223. The optical channel 223 may be configured to receive and/or transmit an optical signal. The optical channel 223 may be optically coupled with the optical receiving element 221. The optical channel 223 may be optically coupled with the optical emitting element 222. The optical channel 223 may extend between the surfaces 22s1 and 22s2 of the photonic component 22. The optical channel 223 may include or be made of silicon, silicon nitride (Si₃N₄), lithium niobate (LiNbO₃), or a combination thereof. In some embodiments, the photonic component 22 may include an electrical-to-optical converter (not shown) and an optical-to-electrical converter (not shown) to convert an optical signal and/or an electrical signal.

In some embodiments, the electronic component 52 may be disposed on or disposed over the surface 21s2 of the photonic component 21. In some embodiments, the electronic components 51 and 52 may be arranged side by side. The electronic component 52 may be configured to process and/or modulate an electrical signal. For example, the electronic component 52 may include an EIC and/or other suitable ICs. The electronic component 52 may have a surface 52s1 (or a lower surface) and a surface 52s2 (or an upper surface) opposite to the surface 52s1. The surface 52s1 of the electronic component 52 may face the surface 21s2 of the photonic component 21. The electronic component 52 may include redistribution structures (not annotated) over the surfaces 52s1 and 52s2. The electronic component 52 may include electrical connections (not annotated), such as solder balls, over the surfaces 52s1 and 52s2.

In some embodiments, the electronic component 52 may include a plurality of conductive vias 521. The conductive via 521 may extend between the surface 52s1 and surface 52s2 of the electronic component 51. In some embodiments, the conductive via 521 may be configured to receive and/or transmit an electrical signal (or a processed electrical signal). The conductive via 521 may include, for example, a through-silicon via (TSV) or other suitable elements. The electronic component 52 may include redistribution structures (not annotated) over the surface 52s1 and surface 52s2. The electronic component 52 may include electrical connections (not annotated), such as solder balls, over the surfaces 52s1 and 52s2.

The photonic component 23 may be disposed on or disposed over the surface 52s2 of the electronic component 52. In some embodiments, the photonic components 22 and 23 may be arranged side by side. The photonic component 23 may be configured to process, receive, and/or transmit optical and/or electrical signals. In some embodiments, the photonic component 23 may be configured to convert an optical signal to an electrical signal. In some embodiments, the photonic component 23 may be configured to convert an electrical signal to an optical signal. The photonic component 23 may include, but is not limited to, a PIC and/or other suitable ICs. The photonic component 23 may have a surface 23s1 (or a lower surface) and a surface 23s2 (or an upper surface) opposite to the surface 23s1. The surface 23s1 may face the surface 52s2 of the electronic component 52. The photonic component 23 may include a redistribution structure (not annotated) over the surface 23s1, which may be configured to transmit an electrical signal (or a processed signal) to the electronic component 52.

In some embodiments, the optical receiving element 231 may be disposed on or disposed over the surface 23s2 of the photonic component 23. The optical receiving element 231 may be configured to receive an optical signal. The optical receiving element 231 may be coupled with an optical contact region 23r1 of the photonic component 23. In some embodiments, the optical receiving element 231 may include a FAU or other suitable elements.

In some embodiments, the optical emitting element 232 may be disposed on or disposed over the surface 23s2 of the photonic component 23. The optical emitting element 232 may be configured to transmit an optical signal (or a processed optical signal). The optical emitting element 232 may be coupled with the optical contact region 23r1 of the photonic component 23. In some embodiments, the optical emitting element 232 may include a laser diode or other suitable elements.

In some embodiments, the photonic component 23 may include a plurality of optical channels 233. The optical channel 233 may be configured to receive and/or transmit an optical signal. The optical channel 233 may be optically coupled with the optical receiving element 231. The optical channel 233 may be optically coupled with the optical emitting element 232. The optical channel 233 may extend between the surfaces 23s1 and 23s2 of the photonic component 23. The optical channel 233 may include or be made of silicon, silicon nitride (Si₃N₄), lithium niobate (LiNbO₃), or a combination thereof. In some embodiments, the photonic component 23 may include an electrical-to-optical converter (not shown) and an optical-to-electrical converter (not shown) to convert an optical signal and/or an electrical signal.

In some embodiments, the interposer 30a may be disposed on or disposed over the surface 21s2 of the photonic component 21. In some embodiments, the interposer 30a may be disposed on or disposed over the surface 22s1 of the photonic component 22. In some embodiments, the interposer 30a may be disposed between the photonic components 21 and 22. In some embodiments, the interposer 30a may be disposed between the electronic components 51 and 52. In some embodiments, the interposer 30a may be configured to transmit a signal (or a processed signal) along a vertical direction (or orientation). In some embodiments, the interposer 30a may be configured to define a signal path SA between the photonic components 21 and 22 (or between the photonic components 21 and 23). In some embodiments, the signal path SA may indicate a signal path including a vertical transmission path within the interposer 30a. In some embodiments, the signal path SA may include an optical signal path. In some embodiments, the signal path SA may include an electrical signal path. In some embodiments, the signal path SA may include an optical signal path and an electrical signal path.

In some embodiments, the interposer 30a may be configured to transmit a signal (or a processed signal) along a horizontal direction. In some embodiments, the interposer 30a may be configured to define a signal path SB between the photonic components 22 and 23. In some embodiments, the signal path SB may indicate a signal path including a horizontal transmission path within the interposer 30a. The interposer 30s may have a surface 30as1 (or a lower surface) and a surface 30as2 (or an upper surface) opposite to the surface 30as1. The surface 30as1 of the interposer 30a may face the surface 21s2 of the photonic component 21. The surface 30as2 of the interposer 30a may face the surface 22s1 of the photonic component 22 and face the surface 23s1 of the photonic component 23.

In some embodiments, the optical contact 41 may be disposed between the surface 21s2 of the photonic component 21 and the surface 30as1 of the interposer 30a. The optical contact 41 may directly contact the photonic component 21. The optical contact 41 may directly contact the interposer 30a. The optical contact 41 may be coupled with an optical contact region 21r2 of the photonic component 21. The optical contact 41 may be configured to receive and/or transmit an optical signal from the photonic component 21 to the interposer 30a (or from the interposer 30a to the photonic component 21). The optical contact 41 may include a high refractive index material (e.g., refractive index equal to or greater than 1.4). For example, the optical contact 41 may include polyimide (PI), polymethyl-methacrylate (PMMA), polystyrene (PS), and polycarbonate (PC), or other suitable materials. In some embodiments, the optical contact 41 may include an optical channel (e.g., silicon) encapsulated by a dielectric material (e.g., silicon oxide).

In some embodiments, the optical contact 42 may be disposed between the surface 22s1 of the photonic component 22 and the surface 30as2 of the interposer 30a. The optical contact 42 may directly contact the photonic component 22. The optical contact 42 may directly contact the interposer 30a. The optical contact 42 may be coupled with an optical contact region 22r2 of the photonic component 22. The optical contact 42 may be configured to receive and/or transmit an optical signal from the photonic component 22 to the interposer 30a (or from the interposer 30a to the photonic component 22). The optical contact 42 may include a high refractive index material (e.g., refractive index equal to or greater than 1.4). For example, the optical contact 42 may include polyimide, polymethyl-methacrylate, polystyrene, and polycarbonate, or other suitable materials. In some embodiments, the optical contact 42 may include an optical channel (e.g., silicon) encapsulated by a dielectric material (e.g., silicon oxide).

In some embodiments, the optical contact 43 may be disposed between the surface 23s1 of the photonic component 23 and the surface 30as2 of the interposer 30a. The optical contact 43 may directly contact the photonic component 23. The optical contact 43 may directly contact the interposer 30a. The optical contact 43 may be coupled with an optical contact region 23r2 of the photonic component 23. The optical contact 43 may be configured to receive and/or transmit an optical signal from the photonic component 23 to the interposer 30a (or from the interposer 30a to the photonic component 23). The optical contact 43 may include a high refractive index material (e.g., refractive index equal to or greater than 1.4). For example, the optical contact 43 may include polyimide, polymethyl-methacrylate, polystyrene, and polycarbonate, or other suitable materials. In some embodiments, the optical contact 43 may include an optical channel (e.g., silicon) encapsulated by a dielectric material (e.g., silicon oxide).

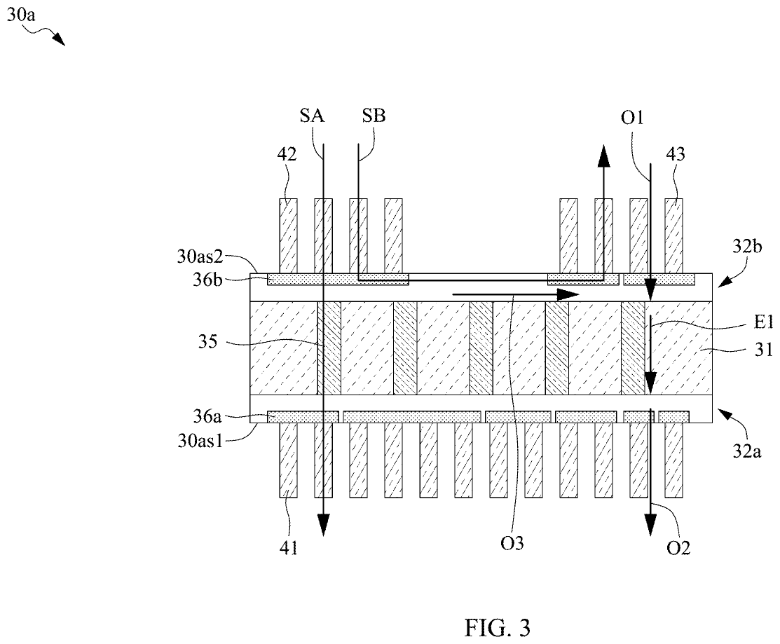

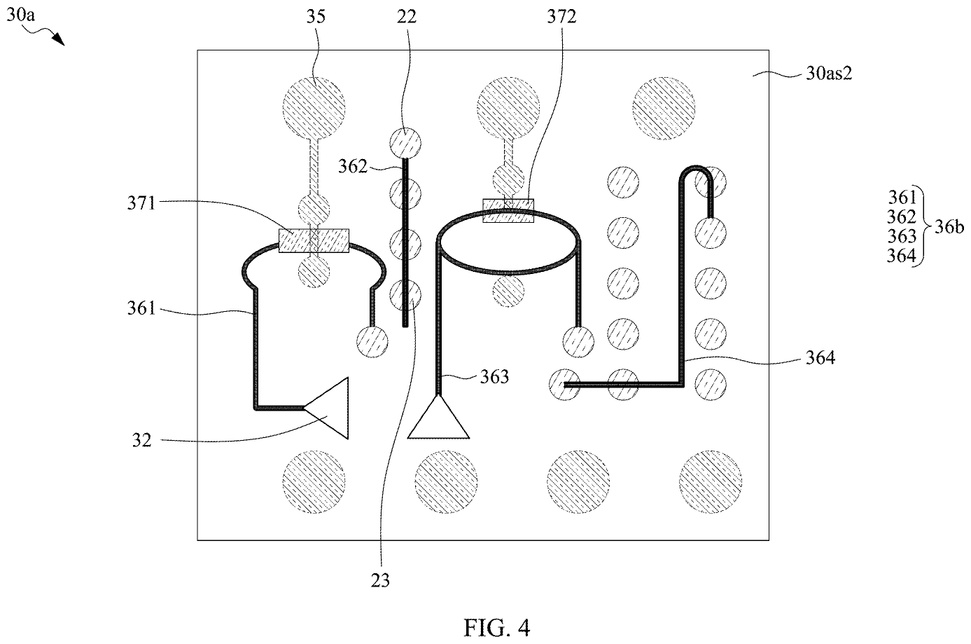

FIG. 3 is a partial enlarged view of the optoelectronic package structure 1a according to some embodiments of the present disclosure. FIG. 4 illustrates a layout of the interposer 30a from the side of surface 30as2. In some embodiments, the interposer 30a may include a substrate 31, a signal transmission layer 32a, a signal transmission layer 32b, conductive vias 35, a waveguide 36a and a waveguide 36b.

As shown in FIG. 3, the substrate 31 may include a semiconductor substrate, which may include silicon, germanium, or other suitable materials. The substrate 31 may include a compound semiconductor, which may include silicon carbide, gallium arsenic, gallium phosphide, indium phosphide, indium arsenide, and/or indium antimonide. The substrate 31 may include an alloy semiconductor including SiGe, GaAsP, AlInAs, AlGaAs, GaInAs, GaInP, and/or GaInAsP; the like, or combinations thereof.

The signal transmission layer 32a may be in proximity to, adjacent to, or embedded in and exposed by the surface 30as1 of the interposer 30a. The signal transmission layer 32b may be in proximity to, adjacent to, or embedded in and exposed by the surface 30as2 of the interposer 30a. In some embodiments, the signal transmission layer 32a may vertically overlap the signal transmission layer 32b. In some embodiments, the signal transmission layer 32a may be free from vertically overlapping the signal transmission layer 32b. In some embodiments, the signal transmission layer 32a may be spaced apart from the signal transmission layer 32b from a top view perspective. In some embodiments, the signal transmission layer 32a may be free from horizontally overlapping the signal transmission layer 32b. Each of the signal transmission layers 32a and/or 32b may be configured to receive, transmit, and/or convert a signal. In some embodiments, each of the signal transmission layers 32a and/or 32b may include at least one dielectric layer and other elements, such as a photoelectric converter, waveguide, redistribution structure, or other suitable elements embedded therein. For example, the signal transmission layer 32a may include a waveguide 36a (or a waveguide layer) configured to transmit an optical signal, and the signal transmission layer 32b may include a waveguide 36b (or a waveguide layer) configured to transmit an optical signal. Each of the signal transmission layers 32a and/or 32b may be configured to convert an optical signal to an electrical signal. Each of the signal transmission layers 32a and/or 32b may be configured to convert an electrical signal to an optical signal. Each of the signal transmission layers 32a and/or 32b may include an interconnection (not shown) for transmitting an optical signal and/or electrical signal. The signal transmission layer 32a may be electrically coupled with the conductive via 35. The signal transmission layer 32b may be electrically coupled with the conductive via 35. In some embodiments, the signal transmission layer 32a may be regarded as a lower portion of a signal transmission structure (or a lower portion of the interposer 30a), and the signal transmission layer 32b may be regarded as an upper portion of a signal transmission structure (or an upper portion of the interposer 30a).

In some embodiments, the conductive via 35 may extend between the signal transmission layers 32a and 32b. The conductive via 35 may penetrate the substrate 31. The conductive via 35 may be configured to transmit an electrical signal between the signal transmission layers 32a and 32b. In some embodiments, the conductive via 35 may function as a part of a signal path for transmitting a signal. In some embodiments, the conductive via 35 may function as a part of a signal path extending between the waveguides 36a and 36b (or between the signal transmission layers 32a and 32b). The conductive via 35 may include a TSV. The conductive via 35 may include copper (Cu), aluminum (Al), titanium (Ti), chromium (Cr), tin (Sn), gold (Au), silver (Ag), nickel (Ni) or other suitable materials.

The waveguide 36a may be disposed within or embedded in the signal transmission layers 32a. The waveguide 36a may be optically coupled with the optical contact 41. The waveguide 36a may include or be made of silicon, silicon nitride (Si₃N₄), lithium niobate (LiNbO₃), or a combination thereof. In some embodiments, the refractive index of the waveguide 36a may equal or exceed about 2.0, about 2.2, about 3, or about 3.5.

The waveguide 36b may be disposed within or embedded in the signal transmission layers 32b. The waveguide 36b may be optically coupled with the optical contact 42. The waveguide 36b may be optically coupled with the optical contact 43. The waveguide 36b may include or be made of silicon, silicon nitride (Si₃N₄), lithium niobate (LiNbO₃), or a combination thereof. In some embodiments, the refractive index of the waveguide 36b may equal or exceed 2.0, 2.2, 3, or 3.5. In some embodiments, the waveguide 36a may be regarded as a lower portion of a waveguide (or waveguide layer), and the waveguide 36b may be regarded as an upper portion of a waveguide (or waveguide layer).

In some embodiments, the signal path SA may pass through the optical contact 42 (or 43), signal transmission layer 32b, the conductive via 35, the signal transmission layer 32a, and the optical contact 41. In some embodiments, the signal path SA may involves a photoelectric conversion. Said photoelectric conversion may be performed in the signal transmission layers 32a and 32b, which includes photoelectric converters as shown in FIG. 4. As shown in FIG. 3, an optical signal O1 may be transmitted between the optical contact 42 (or 43) and the signal transmission layer 32b. The optical signal O1 may be converted to an electrical signal E1. The electrical signal E1 may be transmitted within the signal transmission layers 32a and 32b. The electrical signal E1 may be converted to an optical signal O2. The optical signal O2 may be transmitted between the optical contact 41 and the signal transmission layer 32a.

In some embodiments, the signal path SB may pass through the optical contact 42, the waveguide 36b, and optical contact 43. In some embodiments, the signal path SB does not involve photoelectric conversion. For example, an optical signal O3 may pass through the optical contact 42, the waveguide 36b, and the optical contact 43.

As shown in FIG. 4, the interposer 30a may include grating couplers 33, a photoelectric converter 371, and a photoelectric converter 372. The grating coupler 33 may be in proximity to, adjacent to, or embedded in and exposed by the surface 30as2 of the interposer 30a. In some embodiments, the grating coupler 33 may be configured to receive and/or transmit an optical signal from the photonic component 22 and/or 23. In some embodiments, the grating coupler 33 may be optically coupled with the optical contact region (e.g., 22r2 and/or 23r2 as shown in FIG. 2) of the photonic component 22 and/or 23. The optical signal from the photonic component 22 and/or 23 may be transmitted to the grating coupler 33 through a medium, which may include air or filler filling between the photonic component 22 (or 23) and the interposer 30a in accordance with some embodiments.

The photoelectric converters 371 and 372 may be disposed within the signal transmission layer 32b. In some embodiments, each of the photoelectric converters 371 and 372 may be configured to convert an optical signal to an electric signal or convert an electric signal to an optical signal. For example, the photoelectric converter 371 may include an electrical-to-optical converter, and the photoelectric converter 372 may include an optical-to-electrical converter. In some embodiments, each of the photoelectric converters 371 and 372 may be optically coupled with the waveguide 36b. In some embodiments, each of the photoelectric converters 371 and 372 may be electrically coupled with the conductive via 35. In some embodiments, each of the photoelectric converters 371 and 372 may be coupled between a waveguide (e.g., 36a or 36b) and a conductive via (e.g., 35). In some embodiments, the photoelectric converter 371 may include a photo detector or other suitable elements. In some embodiments, the photoelectric converter 372 may include an optical modulator or other suitable elements.

In some embodiments, the waveguide 36b may include parts 361, 362, 363, and 364. Each of the parts 361, 362, 363, and 364 may be spaced apart from each other. In some embodiments, each of the parts 361, 362, 363, and/or 364 may be configured to laterally and/or vertically transmit an optical signal. In some embodiments, each of the parts 361, 362, 363, and 364 may be optically coupled with the photonic component 22 and/or 23. For example, the part 362 may be optically coupled with the photonic components 22 and 23. The part 362 may connect the photonic components 22 and 23. In some embodiments, each of the parts 361, 362, 363, and/or 364 may be coupled with the conductive via 35.

Similarly, the interposer 30a may include grating couplers in proximity to, adjacent to, or embedded in and exposed by the surface 30as1 of the interposer 30a. The signal transmission layer 32a may include a photoelectric converter(s). The waveguide 36a may include multiple separated parts, which may be configured to laterally and/or vertically transmit an optical signal.

Please refer back to FIG. 2, in which the optical receiving element 221 may receive and/or transmit an optical signal O4. In some embodiments, the wavelength (or waveband) of the optical signal O4 transmitted within the optical receiving element 221 (or within photonic component 22) may be substantially the same as that of the optical signal O1 transmitted within the interposer 30a. In some embodiments, the wavelength (or waveband) of the optical signal O4 transmitted within the optical receiving element 221 (or within photonic component 22) may be substantially the same as that of the optical signal O3 transmitted within the interposer 30a. In some embodiments, the wavelength (or waveband) of the optical signal O4 transmitted within the optical receiving element 221 (or within photonic component 22) may be different from that of the optical signal O1 transmitted within the interposer 30a. In some embodiments, the wavelength (or waveband) of the optical signal O4 transmitted within the optical receiving element 221 (or within photonic component 22) may be different from that of the optical signal O3 transmitted within the interposer 30a.

In some embodiments, the photonic components 21 and 22 may share the electronic component 51. For example, the electronic component 51 may be configured to receive, process, and/or transmit an electrical signal E2 transmitted between the photonic components 21 and 22. The electronic component 51 may be configured to receive, process, and/or transmit an electrical signal E3 from the photonic component 22. The electronic component 51 may be configured to receive, process, and/or transmit an electrical signal E4 from the photonic component 21.

In a conventional package structure, an interposer may be configured to laterally transmit an optical signal. However, said interposer does not provide a vertical signal path to transmit an optical signal. In this embodiment, the interposer 30a may be configured to define the signal path SA and the signal path SB, both of which involve an optical signal transmission. The optoelectronic package structure 1a can achieve lateral and vertical transmissions of optical signals. Further, the photonic component 21, the interposer 30a, and the photonic component 22 may be vertically stacked to achieve a vertical transmission of an optical signal, which facilitates a flexible package design in comparison with the conventional package structure.

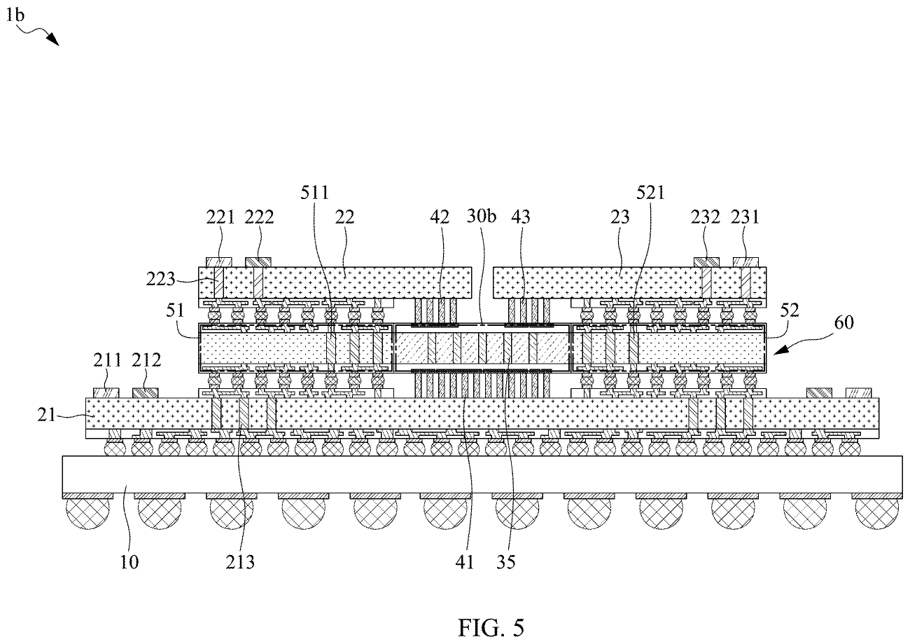

FIG. 5 is a cross-section of an optoelectronic package structure 1b according to some embodiments of the present disclosure. The optoelectronic package structure 1b is similar to the optoelectronic package structure 1a as shown in FIG. 2, with differences therebetween as follows.

In some embodiments, the optoelectronic package structure 1b may include an interposer 30b. In some embodiments, the interposer 30b may be configured to laterally and/or vertically transmit an optical signal(s). In some embodiments, the interposer 30b may be similar to the interposer 30a. In some embodiments, the interposer 30b, the electronic component 51, and the electronic component 52 may share a common substrate 60. For example, the common substrate 60 may include a first region defining the electronic component 51, a second region defining the interposer 30b, and a third region defining the electronic component 52. In some embodiments, multiple semiconductor processes may be performed on the common substrate 60 to form components (e.g., ICs, TSVs, waveguides, photoelectric converters, and the like) of the electronic component 51, the electronic component 52, and the interposer 30b. Such design may simplify the manufacturing process of producing the optoelectronic package structure 1b.

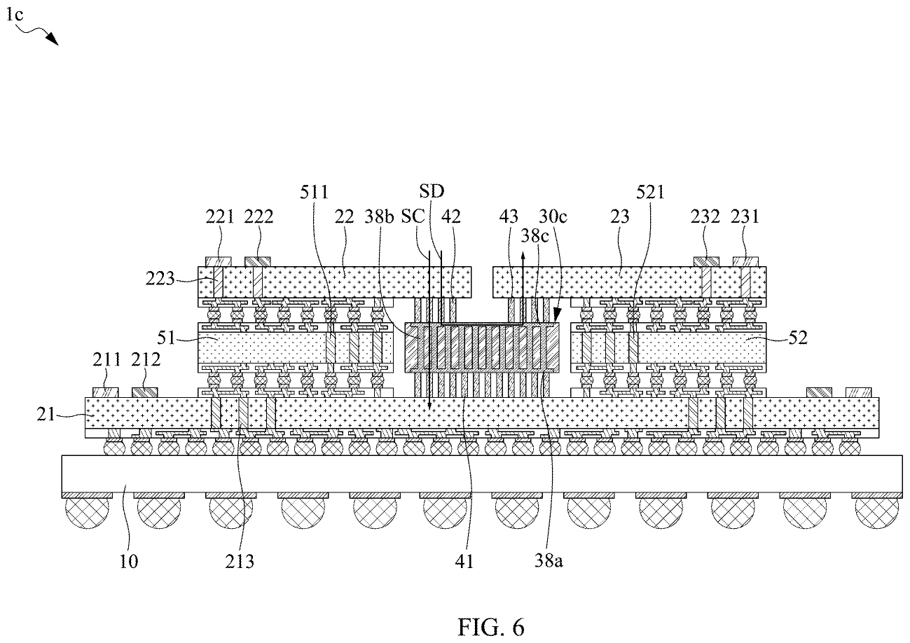

FIG. 6 is a cross-section of an optoelectronic package structure 1c according to some embodiments of the present disclosure. The optoelectronic package structure 1c is similar to the optoelectronic package structure 1a as shown in FIG. 2, with differences therebetween as follows.

In some embodiments, the optoelectronic package structure 1c may include an interposer 30c. In some embodiments, the interposer 30c may be configured to laterally and/or vertically transmit an optical signal(s). In some embodiments, the interposer 30c may include waveguides 38a, 38b, and 38c.

Each of the waveguides 38a, 38, and 38c may be configured to transmit an optical signal. In some embodiments, the waveguide 38a may be optically coupled with the optical contact 41. In some embodiments, the waveguide 38c may be optically coupled with the optical contact 42. In some embodiments, the waveguide 38c may be optically coupled with the optical contact 43. In some embodiments, the waveguide 38b may extend between the waveguides 38a and 38c. In some embodiments, the waveguide 38b may be substantially perpendicular to the waveguide 38a (or 38c). In some embodiments, the waveguide 38b may be configured to vertically transmit an optical signal. In some embodiments, the waveguide 38c may be configured to laterally transmit an optical signal. In some embodiments, the waveguide 38b may be optically coupled with the waveguides 38a and 38c, and may be configured to provide a signal path (or a vertical signal path) so that a signal (e.g., an optical signal) may pass through the waveguide 38b and be transmitted vertically from the upper surface to the lower surface of the interposer 30c (or from the lower surface to the upper surface of the interposer 30c). Each of the waveguides 38a, 38, and 38c may include or be made of silicon, silicon nitride (Si₃N₄), lithium niobate (LiNbO₃), or a combination thereof. In some embodiments, the refractive index of the waveguides 38a, 38, and 38c may equal or exceed 2.0, 2.2, 3, or 3.5.

In some embodiments, the interposer 30c may be configured to transmit a signal (or a processed signal) along a vertical direction. In some embodiments, the interposer 30c may be configured to define a signal path SC between the photonic components 21 and 22. In some embodiments, the interposer 30c may be configured to transmit a signal (or a processed signal) along a horizontal direction. In some embodiments, the interposer 30c may be configured to define a signal path SD between the photonic components 22 and 23. In some embodiments, the signal path SC may pass through the optical contact 42, the waveguides 38c, 38b, and 38a as well as the optical contact 41. In some embodiments, the signal path SC does not involve a photoelectric conversion. In some embodiments, the signal path SD may pass through the optical contact 42, the waveguide 38c, and the optical contact 43. In some embodiments, the signal path SD does not involve a photoelectric conversion. The photoelectric conversion may be omitted from the interposer 30c, which may improve efficiency of transmission of an optical signal.

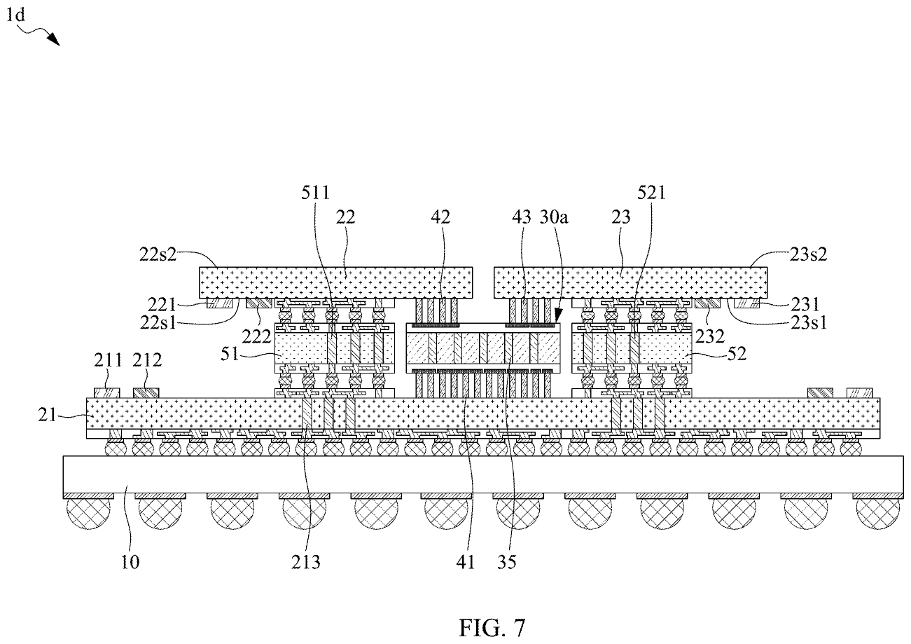

FIG. 7 is a cross-section of an optoelectronic package structure 1d according to some embodiments of the present disclosure. The optoelectronic package structure 1d is similar to the optoelectronic package structure 1a as shown in FIG. 2, with differences therebetween as follows.

In some embodiments, the optical receiving element 221 and the optical emitting element 222 may be disposed on or disposed over the surface 22s1 of the photonic component 22. In some embodiments, the optical receiving element 231 and the optical emitting element 232 may be disposed on or disposed over the surface 23s1 of the photonic component 23. Since all of the optical receiving element 221, the optical emitting element 222, and the I/O terminals (e.g., electrical connections) of the photonic component 22 are disposed over the surface 22s1 of the photonic component 22, the optical signal received from the optical receiving element 221 may be transmitted to the electronic component 51 without a vertical path, which passes through the optical channel 223 as shown in FIG. 2. In this embodiment, an optical channel, such as the optical channel 223 as shown in FIG. 2, may be omitted.

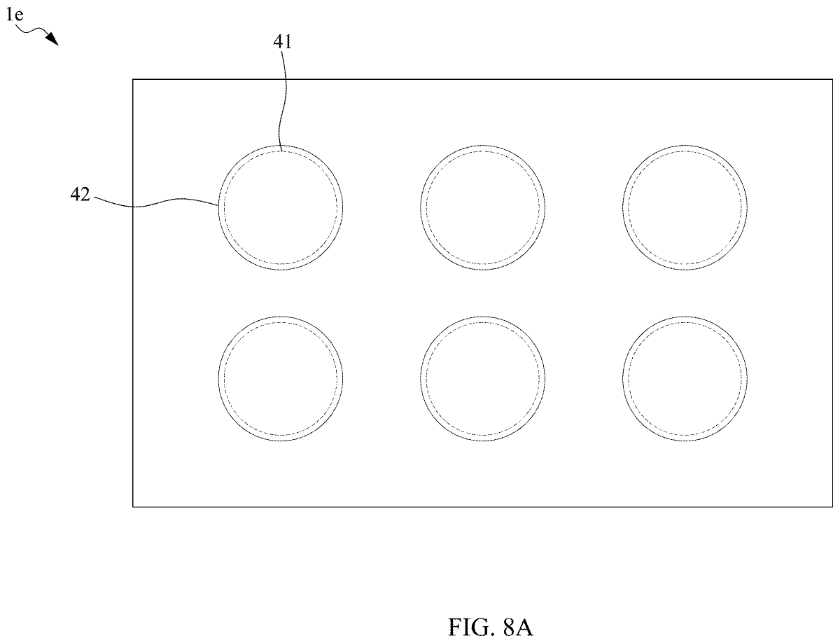

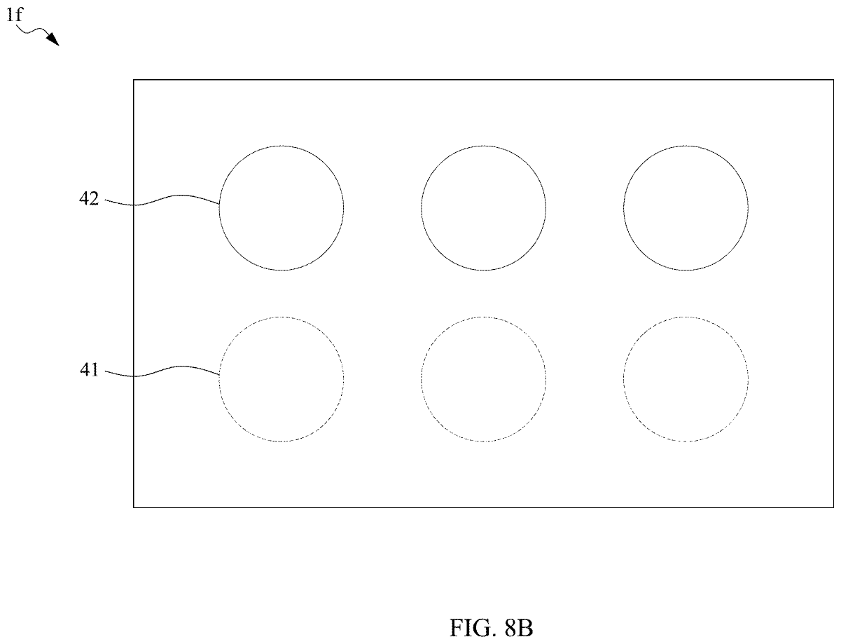

FIG. 8A illustrates a layout of optical contacts of an optoelectronic package structure 1e according to some embodiments of the present disclosure.

In some embodiments, the optical contact 41 may vertically overlap the optical contact 42. In some embodiments, the optical contact 41 may have a dimension (e.g., length, width, diameter, and/or area) the same as that of the optical contact 42.

FIG. 8B illustrates a layout of optical contacts of an optoelectronic package structure 1f according to some embodiments of the present disclosure.

In some embodiments, the optical contact 41 may be at least partially free from vertically overlapping the optical contact 42. In some embodiments, the optical contact 41 may be completely free from vertically overlapping the optical contact 42. In other embodiments, the optical contact 41 may partially overlap the optical contact 42.

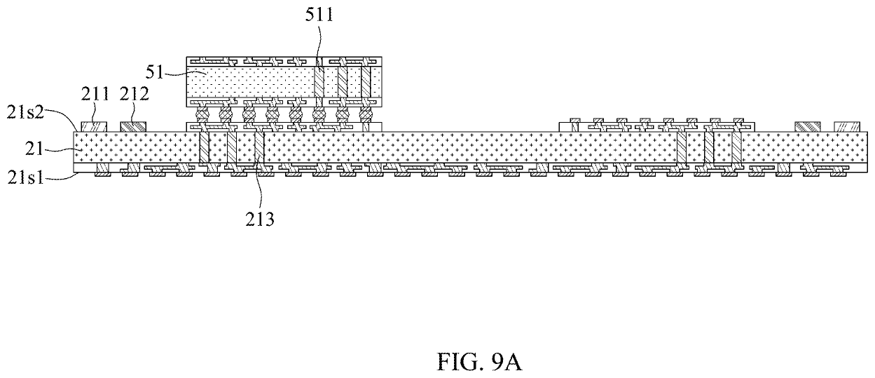

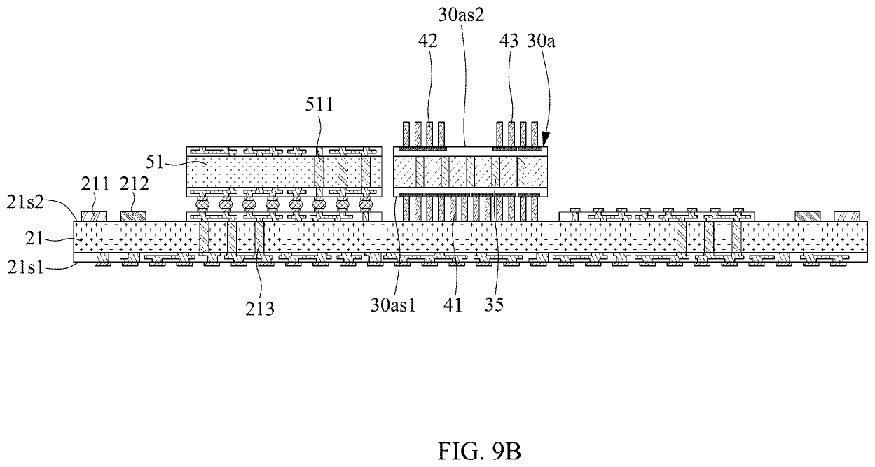

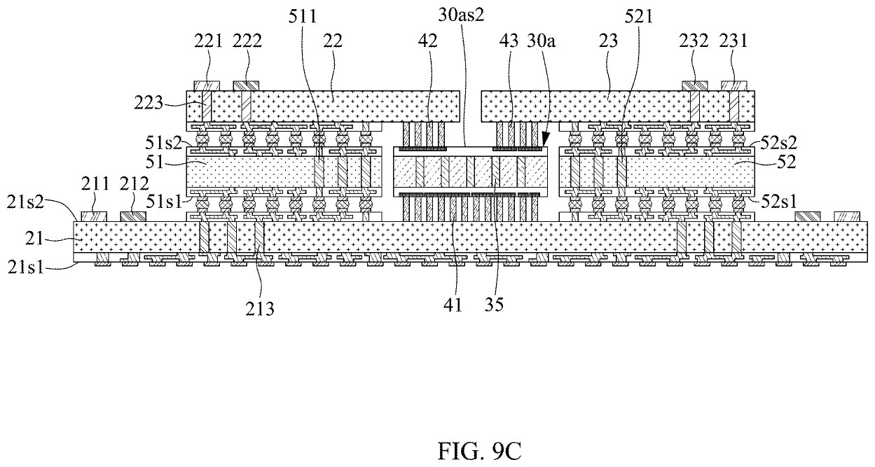

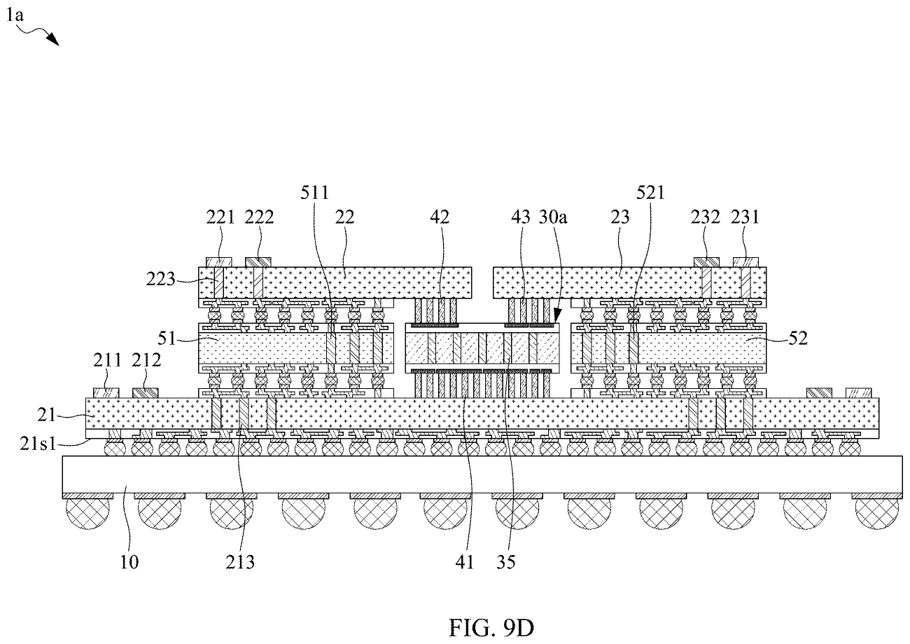

FIG. 9A, FIG. 9B, FIG. 9C, and FIG. 9D illustrates one or more stages of an example of a method for manufacturing an optoelectronic package structure according to some embodiments of the present disclosure.

Referring to FIG. 9A, the photonic component 21 may be provided. The optical receiving element 211 and the optical emitting element 212 may be formed on the surface 21s2 of the photonic component 21. The electronic component 51 may be attached to the surface 21s2 of the photonic component 21. In some embodiments, the electronic component 51 may be attached to the photonic component 21 by flip chip bonding technique.

Referring to FIG. 9B, the interposer 30a may be attached to the surface 21s2 of the photonic component 21. In some embodiments, the optical contacts 41, 42, and 43 may be formed on the surface 30as1 and/or surface 30as2 of the interposer 30a. The optical contact 41 may be attached to the surface 21s2 of the photonic component 21.

Referring to FIG. 9C, the photonic component 22 may be attached to the surface 51s2 of the electronic component 51 and to the surface 30as2 of the 30. Similarly, the electronic component 52 may be attached to the surface 21s2 of the photonic component 21. In some embodiments, the electronic component 52 may be attached to the photonic component 21 by flip chip bonding technique. The photonic component 23 may be attached to the surface 52s2 of the electronic component 52 and to the surface 30as2 of the 30.

Referring to FIG. 9D, the carrier 10 may be attached to the surface 21s1 of the photonic component 21. As a result, an optoelectronic package structure, such as the optoelectronic package structure as shown in FIG. 2, may be produced.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only and that practical implementations of the structures described herein can be spatially arranged in any orientation or manner, provided that the merits of arrangements of this disclosure are not deviated from by such an arrangement.

As used herein the term “active surface” may refer to a surface of an electronic component or passive element on which contact terminals such as contact pads are disposed. The term “active surface” may also refer to a surface of a photonic component along which a waveguide is disposed, and the waveguide may be disposed adjacent to the active surface.

As used herein, the term “processing a signal” may refer to a change of logic values (e.g., “0” and/or “1”) of a signal. As used herein, the term “processing a signal” may refer to a change of a wavelength (or a waveband) of a signal (e.g., an optical signal). As used herein, the term “processing a signal” may refer to a change of an intensity, amplitude, magnitude, frequency, phase, duration, shape, and/or polarization of a signal.

As used herein, the term “vertical” is used to refer to upward and downward directions, whereas the term “horizontal” refers to directions transverse to the vertical orientations.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no exceeding 5 μm, no exceeding 2 μm, no exceeding 1 μm, or no exceeding 0.5 μm. A surface can be deemed to be substantially flat if a displacement between the highest point and the lowest point of the surface is no exceeding 5 μm, no exceeding 2 μm, no exceeding 1 μm, or no exceeding 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity exceeding approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit, and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A optoelectronic package structure, comprising:
a first photonic component disposed over a second photonic component; and
an interposer optically coupled between the first photonic component and the second photonic component and configured to define a first signal path therebetween.

2. The optoelectronic package structure of claim 1, further comprising:
a first optical contact disposed between the first photonic component and the interposer; and
a second optical contact disposed between the second photonic component and the interposer,
wherein the first optical contact is free from overlapping the second optical contact along a vertical direction.

3. The optoelectronic package structure of claim 1, wherein the interposer comprises a first waveguide in an upper portion of the interposer and a second waveguide in a lower portion of the interposer.

4. The optoelectronic package structure of claim 1, wherein the electronic component is configured to process a first electrical signal from the first photonic component and a second electrical signal from the second photonic component.

5. The optoelectronic package structure of claim 1, wherein the first photonic component comprises a first optical contact region coupled with the interposer and a second optical contact region coupled with a fiber array unit.

6. The optoelectronic package structure of claim 1, further comprising:
a third photonic component disposed over the second photonic component, wherein the first photonic component and the third photonic component are arranged side by side.

7. The optoelectronic package structure of claim 6, wherein the interposer is configured to support the first photonic component and the third photonic component.

8. The optoelectronic package structure of claim 7, wherein the interposer comprises a first waveguide configured to transmit an optical signal between the first photonic component and the third photonic component.

9. The optoelectronic package structure of claim 1, wherein the first signal path comprises an optical signal or an electrical signal.

10. A optoelectronic package structure, comprising:
an interposer configured to transmit a first optical signal along a vertical direction and configured to transmit a second optical signal along a horizontal direction.

11. The optoelectronic package structure of claim 10, wherein the interposer comprises:
a first waveguide disposed along a first surface of the interposer and configured to transmit the second optical signal; and
a second waveguide configured to transmit the first optical signal from the first surface to a second surface, opposite to the first surface, of the interposer.

12. The optoelectronic package structure of claim 10, further comprising:
a first photonic component, a second photonic component, and a third photonic component, wherein the first optical signal is transmitted from the first photonic component to the second photonic component, and the second optical signal is transmitted from the first photonic component to the third photonic component.

13. The optoelectronic package structure of claim 12, further comprising:
an optical contact connecting and directly contacting the first photonic component and the interposer.

14. The optoelectronic package structure of claim 12, further comprising:
an electronic component disposed between the first photonic component and the second photonic component, wherein the electronic component is configured to process an electrical signal from the first photonic component or from the second photonic component.

15. The optoelectronic package structure of claim 12, wherein the second photonic component vertically overlaps the first photonic component and the third photonic component.

16. A optoelectronic package structure, comprising:
a first photonic component and a second photonic component; and
an interposer configured to communicate the first photonic component and the second photonic component, wherein the interposer comprises a first waveguide optically coupled with the first photonic component and a second waveguide spaced apart from the first waveguide and optically coupled with the second photonic component.

17. The optoelectronic package structure of claim 16, further comprising:
a signal path extending between the first waveguide and the second waveguide.

18. The optoelectronic package structure of claim 17, further comprising:
a photoelectric converter coupled between the first waveguide and the signal path.

19. The optoelectronic package structure of claim 16, further comprising:
a third waveguide coupled with the first waveguide and the second waveguide, wherein the first waveguide is substantially perpendicular to the third waveguide.

20. The optoelectronic package structure of claim 16, further comprising:
an optical contact optically coupled between the first photonic component and the first waveguide.
